(19) United States
(12) Patent Application Publication
(10) Pub. No.: US 2009/0028376 A1
(43) Pub. Date: Jan. 29, 2009

(54) Diaphragm for loudspeaker and loudspeaker

(76) Inventors: Fumio Saito, Tokyo (JP); Takashi Mikuniya, Tokyo (JP)

Correspondence Address: DENNIS G. LAPOINTE;LAPOINTE LAW GROUP, PL, PO BOX 1294, TARPON SPRINGS, FL, 34688-1294, US

(21) Appl. No.: 10/586,293

(22) PCT Filed: Dec. 8, 2004
(86) PCT No.: PCT/JP04/18283

§ 371 Date: Jul. 13, 2006

(30) Foreign Application Priority Data
Jan. 23, 2004 (JP) 2004-015079

(51) Int. Cl. H04R 11/02; H04R 7/00; H04R 9/06

(52) U.S. Cl. 381/423; 181/173; 181/167

(57) ABSTRACT

A diaphragm body (12) is provided with a plurality of slits (14, 14a) extending from the central part thereof toward the outer circumference. The slits (14, 14a) are filled with a low-elasticity filling material composed of a material different from that of the diaphragm body (12). The slits (14, 14a) are extended rectilinearly or curvedly. The filling material (15) has a Young's modulus lower than that of the principal material of the diaphragm body (12) and/or an internal loss larger than of the principal material of the diaphragm body (12). Furthermore, the filling material (15) employs UV ray and/or visible ray curable resin or thermoplastic resin. Alternatively the filler (15) may be a porous material or a foamed material. The diaphragm body (12) produced by filling the slits (14, 14a) with the filling material (15) is employed for constituting a loudspeaker.

### RELATED APPLICATIONS

This application is a national stage application under 35 USC 371 of international application PCT/JP2004/018283 filed Dec. 8, 2004, which claims priority from Japan application 2004-15079 filed Jan. 23, 2004.

### TECHNICAL FIELD

The present invention relates to a diaphragm for a loudspeaker in acoustic equipment and a loudspeaker, and particularly to a diaphragm which prevents generation of axisymmetrical mode in a vibration mode of a diaphragm in a high range frequency, reduces peaks and dips in a high range, and smoothens frequency characteristics from a low range to the high range to realize favorable sound quality and a loudspeaker using this diaphragm.

### BACKGROUND ART

A diaphragm for a loudspeaker is required to have a smooth frequency characteristic from a low range to a high range.

However, if a main material of a diaphragm body is made of a single material such as pulp, for example, it is well known that vibration modes at high range frequencies become axisymmetrical. In this case, large peaks and dips are generated in the high range side, and the sound quality is not favorable.

FIG. 14 shows the vibration mode by laser Doppler measurement of a diaphragm driven at a frequency of 6 kHz, in a loudspeaker using the above conventional diaphragm. Also, FIG. 15 shows the frequency characteristics of the same conventional diaphragm. With the conventional diaphragm, a distinctive axisymmetrical vibration mode is generated in the high range, and a remarkable peaks and dips occur.

In order to solve the above problem, as disclosed in Japanese Patent laid-Open No. 50-37427, for example, a large number of damping holes arranged in the swirling state are provided in four rows with intervals of 90 degrees, and a damping compound with high internal loss is filled in these damping holes so as to give discontinuity to the vibration characteristic of the diaphragm to prevent occurrence of a standing wave and occurrence of split vibration and to make sound quality favorable.

[Patent Document 1]: Japanese Patent Laid-Open No. 50-37427

However, with this prior art, since the large number of damping holes should be provided in the diaphragm, manufacture is complicated, and drop of rigidity of the diaphragm due to the large number of damping holes is not preferable.

Also, a work to uniformly fill the damping compound in the large number of damping holes is required, which results in a disadvantage that manufacture is complicated in this point.

The present invention was made in order to solve the above problems and has an object to provide a diaphragm for a loudspeaker which prevents vibration in an axisymmetrical resonance mode in a high range where a remarkable peaks and dips are generated in the frequency characteristic, reduces the peaks and dips and smoothens the frequency characteristic over the whole range, and a loudspeaker using this diaphragm.

### DISCLOSURE OF THE INVENTION

In order to achieve the above object, a diaphragm for a loudspeaker of the present invention is constituted so that slits 14, 14a extending from the center part towards an outer circumference are formed in plural in a diaphragm body 12, and a filling material 15 made of a material different from that of the diaphragm body 12 is filled in these slits 14, 14a.

Since the slits 14, 14a are formed in this way so that the diaphragm body 12 is divided so as to disperse resonance spots, an axisymmetrical mode is not generated in a vibration mode of the diaphragm in a high range frequency, large peaks and dips in the high frequency range are reduced, and the frequency characteristic is smoothened. Therefore, a smooth frequency characteristic can be obtained from a low range to the high range, which makes the sound quality favorable.

Also, in the diaphragm for a loudspeaker of the present invention, the slits 14, 14a are formed in a linear shape or in a curved shape.

Since the slits 14, 14a are formed in the linear shape or curved shape in this way in the present invention, formation is easier than conventional examples in which a large number of damping holes are formed, the filling material 15 can be filled in easily, by which manufacture is facilitated in the entirety.

Also, the diaphragm for a loudspeaker of the present invention uses a material with a smaller Young's modulus and/or a larger internal loss than those of a main material of the diaphragm body 12 as the filling material 15. By this, the resonance of the axisymmetrical mode can be absorbed and dispersed. In here, if a porous material such as foaming material or porous rubber is used as the filling material 15, since they have air layers, and thus, large internal losses, the resonance of the axisymmetrical mode can be absorbed and dispersed, which can make sound quality favorable.

Also, in the diaphragm for a loudspeaker of the present invention, as the filling material 15, a resin which is curable by ultraviolet and/or visible rays or a thermoplastic resin is used.

By using such thermoplastic resin, manufacturing time can be reduced, which is appropriate for mass production, and manufacture itself is facilitated.

Also, in the loudspeaker according to the present invention, a coil bobbin 20 having a voice coil 21 is provided at a center part on the back face of a diaphragm 10 for a loudspeaker, and this coil bobbin 20 is supported to be capable of vibration while the voice coil 21 is arranged in a magnetic gap of a magnetic circuit 30. And, the diaphragm 10 is provided on its outer circumference with an edge 13 through which the diaphragm 10 is supported by a frame 40 in construction. According to this loudspeaker, since the diaphragm 10 in the above construction is provided, its frequency characteristics are smooth over the entire region.

### BRIEF DESCRIPTION OF THE DRAWINGS

FIG. 1 is a plan view of a first preferred embodiment of a loudspeaker using a diaphragm according to the present invention;

FIG. 2 is a longitudinal sectional view showing a construction of the loudspeaker in FIG. 1;

FIG. 3 is a diagram showing a vibration mode of the loudspeaker in FIG. 1;

FIG. 4 is a frequency characteristic diagram of the loudspeaker in FIG. 1;

FIG. 5 is a vibration mode diagram of a second preferred embodiment of the present invention;

FIG. 6 is a frequency characteristic diagram of the second preferred embodiment;

FIG. 7 is a plan view of a third preferred embodiment of a loudspeaker using a diaphragm according to the present invention;

FIG. 8 is a vibration mode diagram of the third preferred embodiment;

FIG. 9 is a frequency characteristic diagram of the third preferred embodiment;

FIG. 10 is a vibration mode diagram of a fourth preferred embodiment of a loudspeaker using the diaphragm according to the present invention;

FIG. 11 is a frequency characteristic diagram of the fourth preferred embodiment;

FIG. 12 is a frequency characteristic diagram of a fifth preferred embodiment of a loudspeaker using the diaphragm according to the present invention;

FIG. 13 is a frequency characteristic diagram of a sixth preferred embodiment of a loudspeaker using the diaphragm according to the present invention;

FIG. 14 is a vibration mode diagram of a loudspeaker using a conventional diaphragm; and

FIG. 15 is a frequency characteristic diagram of the loudspeaker in FIG. 14.

### DESCRIPTION OF REFERENCE NUMERALS

10 Diaphragm
11 Opening portion
12 Diaphragm body
13 Edge
14, 14a Slit
15 Filling material
16 Dust cap
20 Voice coil bobbin
21 Voice coil
22 Damper
30 Magnetic circuit
31 Yoke
32 Center plate
40 Frame

### BEST MODE FOR CARRYING OUT THE INVENTION

In order to describe the present invention in more detail, description will be made below according to the attached drawings.

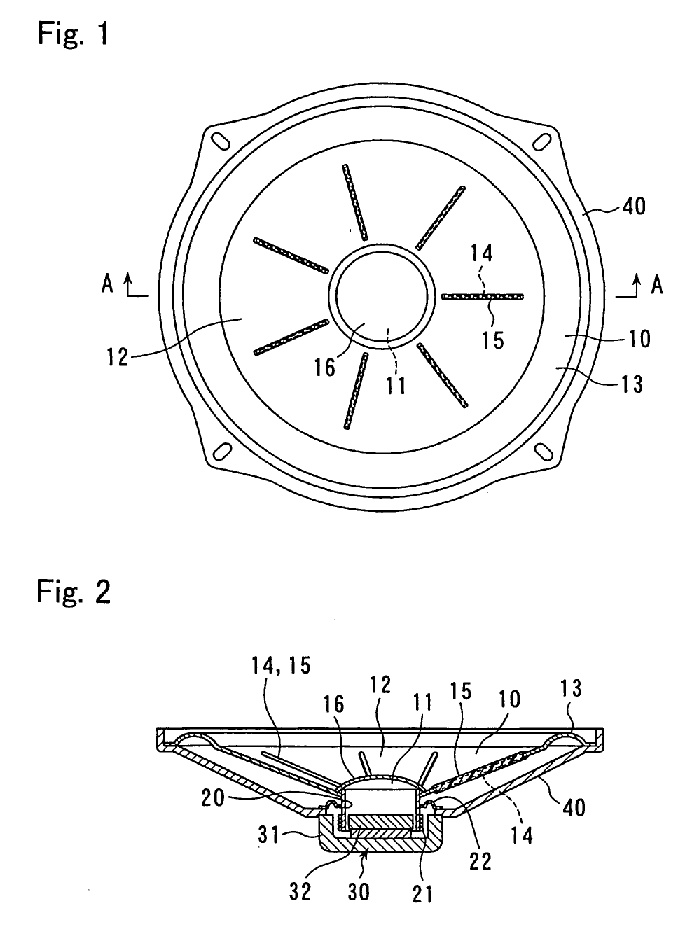

FIG. 1 is a plan view of a loudspeaker using a diaphragm for a loudspeaker in a first preferred embodiment according to the present invention, and FIG. 2 is a longitudinal sectional view of the loudspeaker along A-A line in FIG. 1.

In FIGS. 1 and 2, a diaphragm 10 formed in a circular cone shape with a diameter of 13 cm, for example, is a paper diaphragm made from pulp with Young's modulus of 3.7 GPa and an internal loss of 0.03. At a center portion of a diaphragm body 12 forming a cone shape, a circular opening portion 11 to be a so-called neck portion is formed, and an edge 13 is provided on an outer circumference portion.

In this example, a main material of the diaphragm body 12 is paper, but appropriate reinforcing materials may be mixed.

In the diaphragm body 12, 7 linear slits 14, for example, are formed in radial directions with substantially equal intervals in the circumferential direction.

The slits 14 extend from the outer circumference portion of the opening portion 11 towards the inside of the outer circumference of the diaphragm body 12, and in this example, the slits 14 are set to have the width of 1 mm and the length of 40 mm. This slit width and length are changed appropriately corresponding to the increase/decrease of a diameter of the diaphragm body 12.

In these slits 14, a resin which has, for example, Young's modulus of 13 MPa and an internal loss of 1.2 at 25° C. after curing and is curable by exposure to ultraviolet radiation is filled as the filling material 15 and cured so as to constitute the diaphragm 10.

In this preferred embodiment, since the slits 14 are in the simple linear shape, formation is easy and filling of the filling material 15 is also easy.

In assembling the loudspeaker, one end of a voice coil bobbin 20 in a cylindrical shape is joined by adhesion to the back face side of the opening portion 11. A voice coil 21 is coiled on an outer circumference of the other end of the voice coil bobbin 20 and the voice coil is disposed through a jig in a magnetic gap between an inner surface of a substantially cylindrical outer circumferential wall of a yoke 31 and an outer circumferential face of a center plate arranged at the center constituting an inner-magnet type magnetic circuit 30, for example. An inner circumferential end of a damper 22 is joined by adhesion to an outer circumferential end of the voice coil bobbin 20, and an outer circumferential end of the damper 22 is joined by adhesion to an inner end portion of a frame 40 so that the voice coil bobbin 20 is held capable of vibration. On an outer end side of the frame 40, an outer circumferential end of the edge 13 of the diaphragm 10 is joined by adhesion. Also, a dome-shaped dust cap 16 and the like are provided on a front face side of the opening portion 11 so as to construct the loudspeaker.

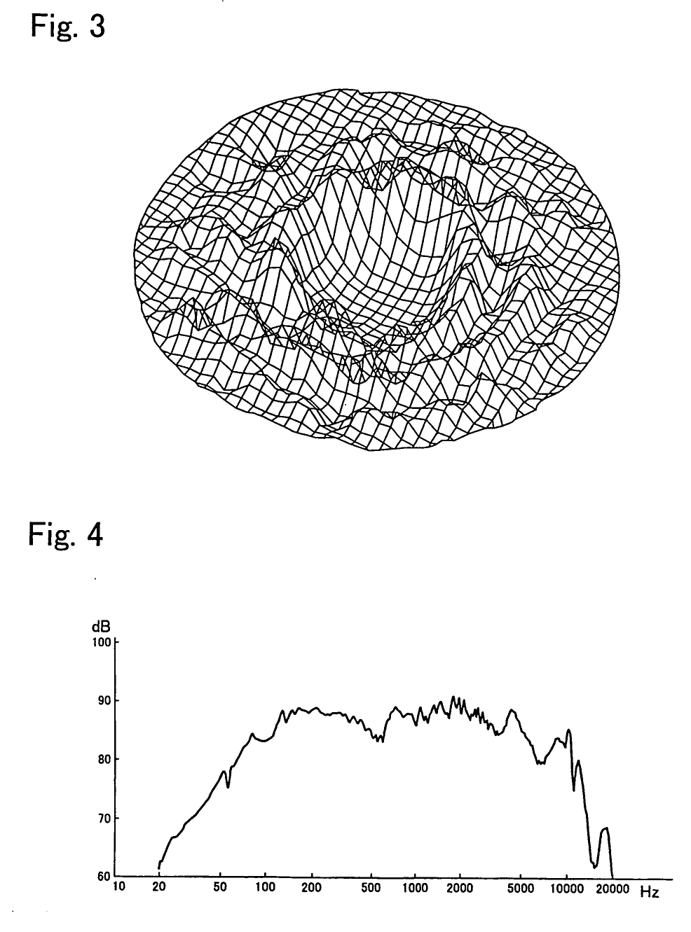

FIG. 3 shows a vibration mode of the vibration of the diaphragm in a preferred embodiment 1 at 6 kHz, which is measured in the laser Doppler method, and FIG. 4 shows a frequency characteristic of this diaphragm. In this preferred embodiment 1, generation of an axisymmetrical mode is suppressed in vibration in a high range and resonance spots are dispersed, by which remarkable peaks and dips are reduced and the frequency characteristic is smoothened. This is because, by dividing a vibration face portion of the diaphragm into several portions with the slits 14 and by using the filling material 15 with less elasticity whose Young's modulus is smaller and internal loss is larger than those of a constituting material of the diaphragm, resonance of the axisymmetrical mode is absorbed and dispersed.

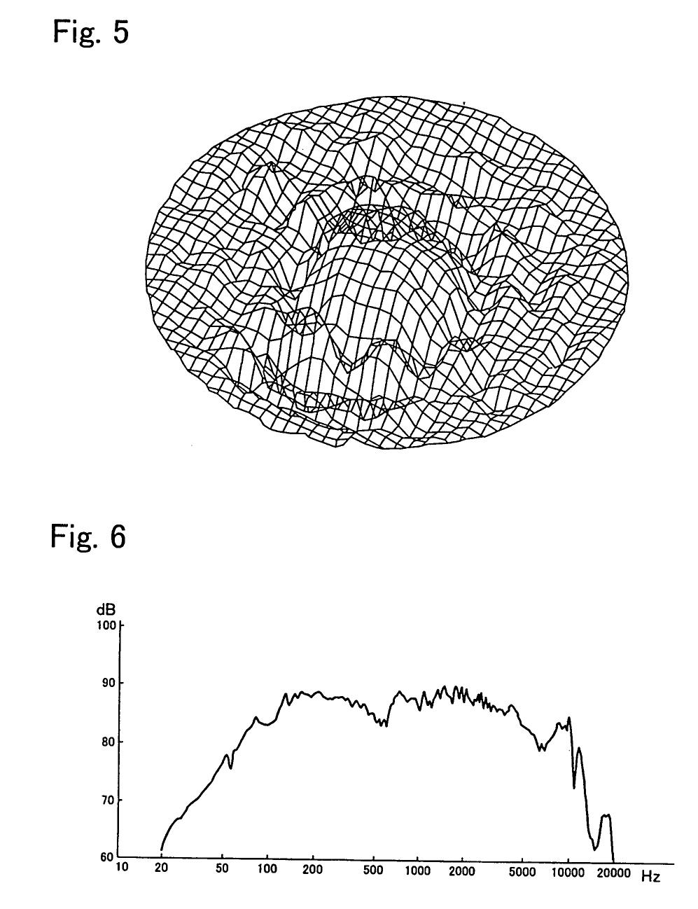

As a second preferred embodiment of the present invention, in a loudspeaker of the same construction as used in the preferred embodiment 1, 10 linear radial slits 14 are formed with the width of 1 mm and the length of 40 mm in the diaphragm body 12 of the diaphragm 10 so that the number of divisions in the circumferential direction of the diaphragm body 12 is changed to 10, and the same ultraviolet curable resin as in the preferred embodiment 1 is filled in these slits 14. The vibration mode of the diaphragm in this preferred embodiment 2 at 6 kHz is shown in FIG. 5 and the frequency characteristic diagram of this diaphragm in FIG. 6. As can be seen from these figures, even if the number of linear radial slits is increased to 10, substantially the same effects as those of the preferred embodiment 1 can be obtained.

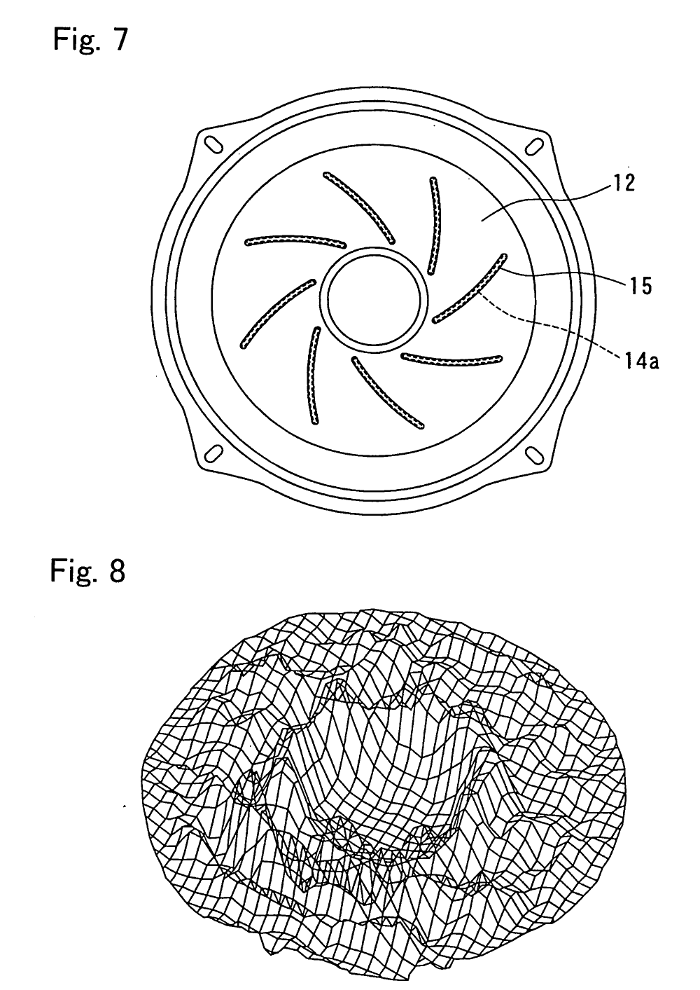

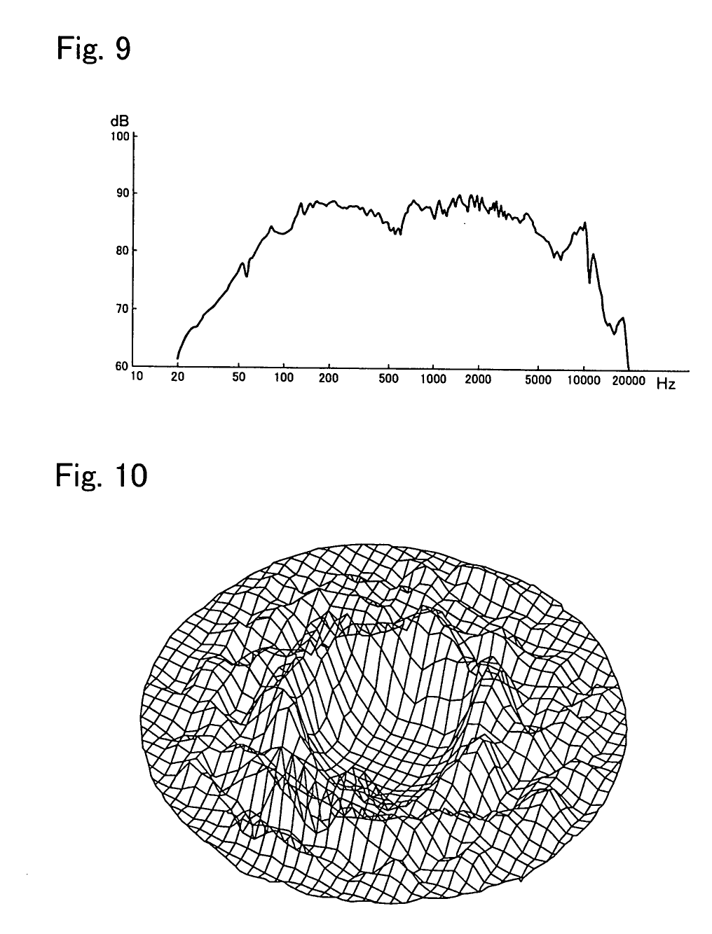

FIG. 7 shows preferred embodiment 3 of the present invention. This preferred embodiment is characterized in that the slits 14a are formed in a curved state like a swirl. The number of the slits 14a is 8 in this example, but it is needless to say that the number may be increased/decreased as necessary. The filling material 15 is also filled in these slits 14a as in the above preferred embodiments. The vibration mode of the diaphragm in this preferred embodiment 3 at 6 kHz is shown in FIG. 8 and the frequency characteristic diagram of this diaphragm in FIG. 9. As can be seen from these figures, even if the slits are formed in the curved shape, substantially the same effects as those of the preferred embodiment 1 can be obtained.

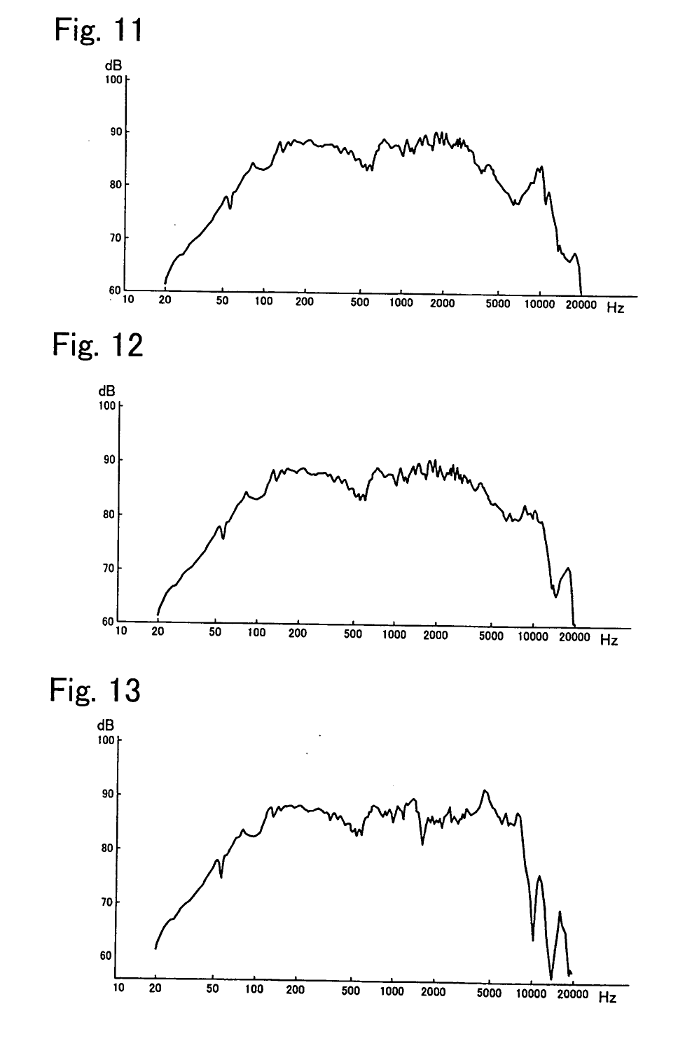

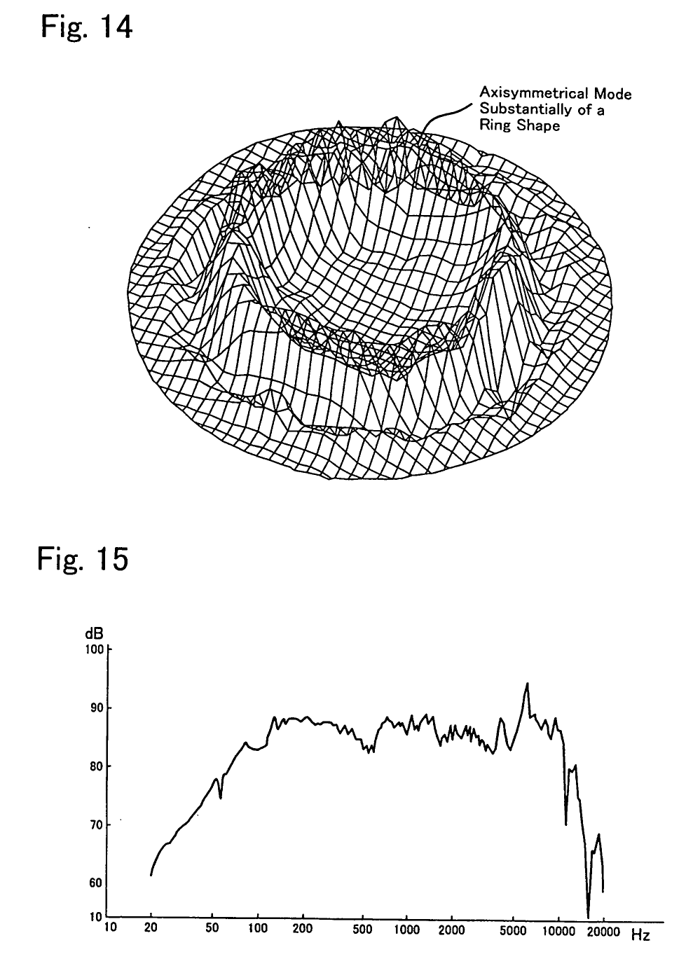

As a fourth preferred embodiment of the present invention, 10 curved slits similar to the 8 curved slits 14a used in the preferred embodiment 3 are formed in the diaphragm body 12, and an ultraviolet curable resin is filled in these slits as the filling material 15. The vibration mode of the diaphragm in this preferred embodiment 4 at 6 kHz is shown in FIG. 10, and the frequency characteristic diagram of this diaphragm in FIG. 11. As can be seen from FIGS. 10 and 11, substantially the same effects as those of the preferred embodiment 1 can be obtained in this case. A resin which is curable by visible rays may be used as the resin.

As a fifth preferred embodiment of the present invention, while the diaphragm material as well as the shape, number and dimension of the slits are the same as those in the preferred embodiment 1, the diaphragm 10 is made using a porous material made of porous rubber with its main component of ethylene propylene diene monomer (EPDM) having Young's modulus of 4.1 MPa and an internal loss of 0.06 at 25° C. as the filling material 15 to be filled in the slits 14 so as to constitute a loudspeaker with the other constructions unchanged. The frequency characteristic diagram of this loudspeaker is shown in FIG. 12. As is clear from the diagram, no remarkable peak or dip is generated even in the high range and a smooth characteristic on the whole is realized, and substantially the same effect as in the preferred embodiment 1 can be obtained even with this filling material 15. It is needless to say that this filling material 15 may be also used in the curved slits 14a.

As a sixth preferred embodiment of the present invention, while the diaphragm material as well as the shape, number and dimension of the slits 14 are the same as those in the preferred embodiment 1, a thermoplastic resin with smaller Young's modulus and larger internal loss than those of the constitutional material of the diaphragm, respectively, is used as the filling material 15 to be filled in the slits 14. This resin is applied to cover at least one of the diaphragm surfaces in a film state under heating and also filled in the slits 14 so as to make the diaphragm 10, and a loudspeaker is constituted with the other constructions unchanged. The frequency characteristic diagram of this loudspeaker is shown in FIG. 13. The remarkable peaks and dips in a high range are reduced as compared with FIG. 15 of a conventional example, and sound quality can be improved. Since the resin is applied on the surface of the diaphragm in this example, the strength of the diaphragm can be improved and waterproof property can be given. When the resin is to be applied, it is preferable to apply it on the whole surface, but it may also be partial. And it is needless to say that this preferred embodiment may be applied to a type having curved slits 14a.

In each of the above preferred embodiments, examples with the numbers of slits dividing the diaphragm body of the diaphragm being 7 to 10 are described, but the number of slits is not limited to them but may be any within a range of 5 to 12 preferably. That is, if the number is smaller than 5, resonance dispersion is not enough and a sufficient effect can not be obtained, while if it exceeds 12, rigidity of the diaphragm is lowered and sound pressure drops.

In each of the preferred embodiments, the slits and filling material 15 are described as being provided in the diaphragm body 12 of the diaphragm 10, but they may be applied to a dust cap.

Also, the shape of the diaphragm 10 is described as a cone in the preferred embodiments, but it is not limited only to the cone but the invention may be similarly applied to a dome-type or planar diaphragm.

It was described that the division by the slits on the vibration surface portion of the diaphragm 10 is made with substantially equal intervals, but the intervals do not have to be strictly equal, but intervals uneven to a certain extent do not prevent the achievement of the object of the present invention.

Also, use of porous rubber as the filling material 15 to be filled in the slits is exemplified in the preferred embodiment 5, but it may be a foaming material. Since foaming materials and porous materials have fine air layers inside, their internal losses are large enough to absorb and disperse the resonance, which is preferable.

As the filling material 15 to be used in the present invention, those with smaller Young's modulus and/or larger internal loss than those of a main material of the diaphragm body 12 are used.

An example produced by using pulp as a main material for the diaphragm body 12 has been described, but a metal diaphragm using aluminum or magnesium or a diaphragm made of plastic may be used.

### INDUSTRIAL APPLICABILITY

The present invention relates to acoustic equipment. A loudspeaker having a diaphragm of the present invention is incorporated in a loudspeaker box (enclosure). When a sound signal outputted from an amplifier is applied to a voice coil, the voice coil and hence the diaphragm is vibrated, and a reproduced sound with a smooth frequency characteristic from a low range to a high range can be obtained.

1. A diaphragm for a loudspeaker, characterized in that a plurality of slits (14, 14a) are formed in a diaphragm body (12) extending from its center portion toward an outer circumference and a filling material (15) made of a material different from the diaphragm body (12) is filled in these slits (14, 14a).

2. The diaphragm for a loudspeaker according to claim 1, characterized in that the slits (14, 14a) extend linearly or in a curved state.

3. The diaphragm for a loudspeaker according to claim 1, characterized in that the filling material (15) has a smaller Young's modulus and/or larger internal loss than a main material of the diaphragm body (12).

4. The diaphragm for a loudspeaker according to claim 1, characterized in that the filling material (15) is made of resin which is curable by ultraviolet and/or visible rays or of thermoplastic resin.

5. The diaphragm for a loudspeaker according to claim 1, wherein the filling material (15) is made of porous material or foaming material.

6. A loudspeaker characterized in that a coil bobbin (20) having a voice coil (21) is provided at a center portion on the back face of a diaphragm (10) for a loudspeaker according to any one of claims 1 to 5, the coil bobbin (20) is supported to be capable of vibration, the voice coil (21) is arranged in a magnetic gap of a magnetic circuit (30), and the diaphragm (10) is supported by a frame (40) through an edge (13) provided on its outer circumference.
